(19) United States
(12) Patent Application Publication
(10) Pub. No.: US 2016/0031198 A1
(43) Pub. Date: Feb. 4, 2016

(54) SYSTEMS AND METHODS FOR LAMINATING SUBSTRATES

(71) Applicant: Ward Kraft, Inc., Fort Scott, KS (US)

(72) Inventors: Young Min Yoo, Fort Scott, KS (US); Jesse Crum, Fort Scott, KS (US)

(21) Appl. No.: 14/815,716

(22) Filed: Jul. 31, 2015

Related U.S. Application Data
(60) Provisional application No. 62/032,261, filed on Aug. 1, 2014.

(51) Int. Cl. B32B 37/00; B32B 37/06; B32B 37/20; B32B 37/10; B32B 37/12; B32B 7/12; B32B 37/08

(52) U.S. Cl. CPC B32B 37/0015; B32B 7/12; B32B 37/0053; B32B 37/06; B32B 37/08; B32B 37/10; B32B 37/12; B32B 37/20; B32B 2310/0806; B32B 2307/412; B32B 2250/02; B32B 2255/00

(57) ABSTRACT

A method for laminating a substrate is disclosed. The method comprises the steps of: (a) providing a substrate on a conveyor belt of a lamination machine, the substrate comprising a transparent layer, an adhesive layer, and a core media layer, where the adhesive layer being positioned between the transparent layer and the core media layer; (b) moving the substrate through a first set of nip rollers; (c) applying a light energy source to the substrate; (d) moving the substrate through a second set of nip rollers to apply pressure to the substrate; and (e) moving the substrate through cooling fans. The light energy source activates the adhesive layer, causing the adhesive layer to soften and form a bond between the transparent layer and the core media layer; and the cooling fans cool the substrate causing the adhesive layer to harden.

### BACKGROUND

1. Field of the Invention

The invention relates generally to the field of laminated substrates.

2. State of the Art

Substrates are often laminated using heat. Specifically, the thermal lamination method of laminating a substrate involves the application of a film and an adhesive layer to a core media layer (e.g., paper). The substrate then moves through a heated roll in a lamination machine which applies heat and pressure to the substrate. The heat melts the adhesive layer, thus adhering the film to the core media layer.

Several issues may be encountered as a result of this lamination method. One common problem is curling or wrinkling of the substrate due to the slow rate of speed at which the substrate is heated. Curling and/or wrinkling of the substrate may be especially problematic if the materials used for the substrate have different shrinkage rages. Thermal energy is also inefficient as common methods often require the first layer to heat and then transfer the heat to the second layer. In order to overcome this issue, it is necessary to use materials with similar shrinkage rates which are often more expensive.

### SUMMARY

The following presents a simplified summary of the invention in order to provide a basic understanding of some aspects of the invention. This summary is not an extensive overview of the invention. It is not intended to identify critical elements of the invention or to limit the scope of the invention. Its sole purpose is to present some concepts of the invention in a simplified form as a prelude to the more detailed description presented below.

In one embodiment of the invention, a method for laminating substrates is disclosed. The method begins by providing a substrate comprising a transparent layer, an adhesive layer, and a core media layer. Then, a light energy source is applied to the substrate, which activates the adhesive layer, causing the adhesive layer to soften and form a bond between the transparent layer and the core media layer. Pressure is subsequently applied to the substrate. The substrate is then cooled, causing the adhesive layer to harden.

In another embodiment of the invention, a method for laminating a substrate comprises the steps of: (a) providing a substrate on a conveyor belt of a lamination machine, the substrate comprising a transparent layer, an adhesive layer, and a core media layer, where the adhesive layer being positioned between the transparent layer and the core media layer; (b) moving the substrate through a first set of nip rollers; (c) applying a light energy source to the substrate; (d) moving the substrate through a second set of nip rollers to apply pressure to the substrate; and (e) moving the substrate through cooling fans. The light energy source activates the adhesive layer, causing the adhesive layer to soften and form a bond between the transparent layer and the core media layer; and the cooling fans cool the substrate causing the adhesive layer to harden.

In still another embodiment of the invention, a method for laminating a substrate, comprises the steps of: (a) providing a substrate on a conveyor belt of a lamination machine, the substrate comprising a transparent layer, an adhesive layer, and a core media layer, where the adhesive layer being positioned between the transparent layer and the core media layer; (b) moving the substrate through a first set of heated nip rollers; (c) applying a light energy source to the substrate; (d) moving the substrate through a second set of chilled nip rollers to apply pressure to the substrate; and (e) moving the substrate through cooling fans. In combination, the heated nip rollers and the light energy source activate the adhesive layer, causing the adhesive layer to soften and form a bond between the transparent layer and the core media layer. Further, in combination, the cooled nip rollers and the cooling fans cool the substrate causing the adhesive layer to harden. The combined temperature of the heated nip rollers and the light energy source does not cause curling or wrinkling of the substrate.

In still yet another embodiment of the invention, a method for laminating a substrate, comprises the steps of: (a) providing a substrate as a web in a lamination machine, the substrate comprising a transparent layer, an adhesive layer, and a core media layer, where the adhesive layer being positioned between the transparent layer and the core media layer; (b) moving the substrate through a first set of heated nip rollers; (c) applying a light energy source to the substrate; (d) moving the substrate through a second set of chilled nip rollers to apply pressure to the substrate; and (e) moving the substrate through cooling fans. In combination, the heated nip rollers and the light energy source activate the adhesive layer, causing the adhesive layer to soften and form a bond between the transparent layer and the core media layer. Further, in combination, the cooled nip rollers and the cooling fans cool the substrate causing the adhesive layer to harden. The combined temperature of the heated nip rollers and the light energy source does not cause curling or wrinkling of the substrate.

### BRIEF DESCRIPTION OF THE SEVERAL VIEWS OF THE DRAWINGS

Illustrative embodiments of the present invention are described in detail below with reference to the attached drawing figures and wherein:

FIG. 1 is a schematic showing an apparatus for laminating a substrate, according to an embodiment; and

FIG. 2 is a schematic illustrating additional components of the apparatus of FIG. 1.

### DETAILED DESCRIPTION

Light curable adhesives are popular throughout the industry due to several recognized benefits, including their fast curing rates and the wide belief that they offer great adhesion for various uses. Light curable adhesives are typically in a liquid form, and the adhesive becomes a solid with exposure to light energy. The light energy cures the light curable adhesive at a rapid rate which results in a solid bond. Despite the potential benefits in the lamination industry, there are several challenges users may face when using light curable adhesive. The liquid characteristic of the light curing adhesive may make it difficult to utilize in a real process. Further, light curable adhesives are quite expensive as compared to other types of adhesives. Additionally, the types of media that may be used with light curable adhesive are limited. When the light curable adhesive solidifies it may become brittle. For this reason light curable adhesive often does not work well for use with flexible media. Also, the light curable adhesive heats as it cures which can make it difficult to find media that will endure this heat.

Disclosed herein are systems and methods for laminating substrates which may overcome these aforementioned challenges. As noted above, a substrate consists of a transparent layer, an adhesive layer, and a core media layer (e.g, paper).

According to one embodiment of the invention, Thermal Formable Plastics (TFPs) may be utilized as the adhesive layer. As suggested by the name, TFPs are materials that respond to heat. TFPs may be in a solid form, for example, powder, film, or resin. TFPs may include, for example, EVA (ethylene vinyl acetate), ink or toner (either liquid or dry). When activated (as discussed below), the TFP may act as an adhesive, or the ink or toner could act as the adhesive by bonding the layers together.

The use of solid thermal formable plastics may make it much easier to handle, and this type of material may be more operator friendly with certain light energy sources. The adhesive layer may be applied between the transparent layer and core media layer in a consistent web without the need for liquid adhesive applying stations, in contrast to other methods.

TFPs may be activated by thermal energy, light energy, or a combination thereof to form it into an adhesive layer. Light energy may consist of ultraviolet, infrared, or other various types of light energy. Light energy may be generated using any source, including LEDs, lasers, lamps, et cetera. The energy from the light energy source may activate the adhesive layer without activating the transparent layer. The activation of the adhesive layer may involve a molecular reaction between the light energy and the adhesive layer, causing the adhesive layer to soften, thus resulting in a bond with the top, bottom, and sides of the film. The adhesive layer may harden as the temperature is lowered creating a solid, strong bonding layer.

Several benefits may be recognized as a result of the use of light energy. First, the bond that is created between the transparent layer and the core media layer using this method may be stronger than the adhesion that is created using other methods. Additionally, the bond that is created may provide for a more resilient laminate that is more scratch resistant. The method may also increase the bonding force of the ink with the core media layer depending on the type of ink. The speed of the process using light energy may also be beneficial, as the layers of the substrate may shrink at the same rate. Finally, method may be more efficient because activation of the adhesive layer may be achieved without wasting time and energy heating (or activating) the transparent layer, as is the case with common thermal lamination methods.

The use of light energy as part of the activation process may also allow for the ability to create high amounts of energy while only generating a low amount of heat, and especially a lower amount of heat than that created as a result of using light curable adhesives. Common thermal lamination methods require contact between the substrate and the nip rollers. The rollers are heated to a temperature sufficient to activate the adhesive. As the substrate passes through the rollers, the rollers heat the top layer (e.g., the transparent layer), and the heat eventually reaches the adhesive layer. The current process does not require such contact, as the activation of the adhesive layer may occur entirely by exposing the substrate to light energy. And as noted, many types of media cannot withstand the heat generated as a result of thermal lamination or light curable adhesives, and therefore, the use of light energy may allow for a wider selection of media, including less expensive media.

One example of a low-cost material that may be selected for use in the process is poly-vinyl chloride (PVC). The melting point of PVC is too low to use in typical thermal lamination methods, as the high heat causes the PVC to burn and/or curl, resulting in a low quality substrate. However, by using light energy in addition to thermal energy, the rollers may be heated to a lower temperature, which may still allow for a strong bond without the undesirable effects of burning and/or curling.

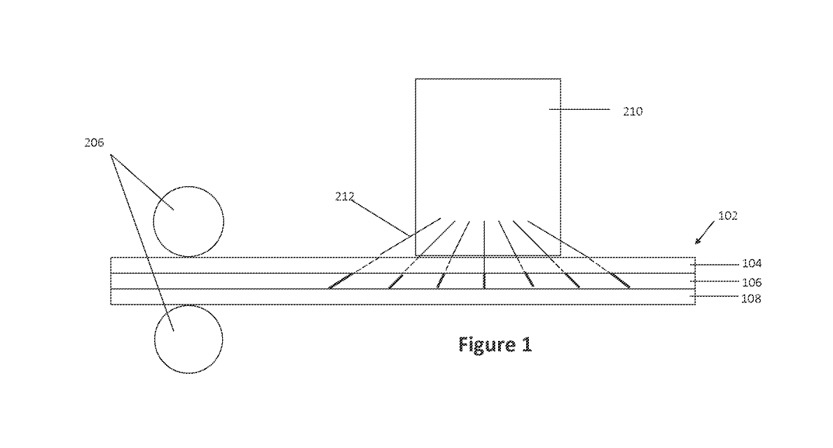

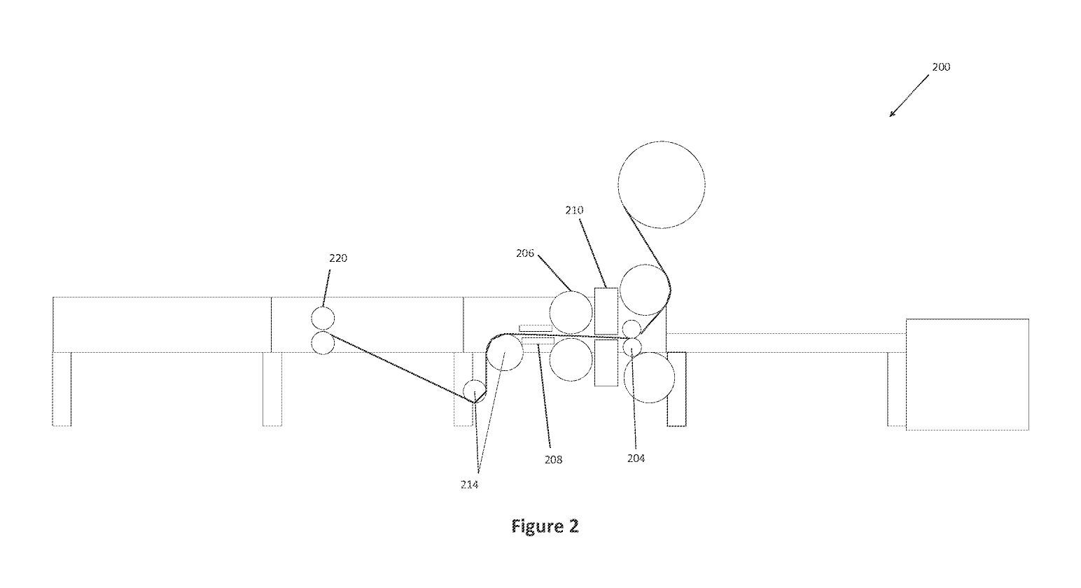

FIGS. 1 and 2 illustrate an exemplary system for laminating substrates. A substrate 102 may comprise a transparent layer 104, an adhesive layer 106, and a core media layer 108. The transparent layer 104 may, for example, comprise PVC and the core media layer 108 may, for example, comprise paper. Other desirable materials may also be employed. The transparent layer 104 may be positioned at a top side of the substrate 102 whereas the core media layer 108 may be positioned at a back side of the substrate 102. The core media layer 108 may optionally include preprinted indicia. The adhesive layer 106 may be positioned between the transparent layer 104 and the core media layer 108, with a first side adjacent the transparent layer 104 and a second side adjacent the core media layer 108.

The method for laminating substrates may begin with sheets of the core media layer 108 moving through the lamination machine 200, as shown in FIG. 2 (i.e, in a conveyor). Alternately, the process may be achieved as a web.

The transparent layer 104 and the adhesive layer 106 may be applied to the core media layer 108, forming the substrate 102. The substrate 102 may then move between a first set of nip rollers 204.

The nip rollers 204 may be heated to various temperatures depending on the materials being used and the desired results. As indicated herein, common thermal lamination methods require the use of high temperatures to be effective, which may preclude the use of less expensive materials. However, by using light energy in addition to (or in lieu of) thermal energy, it may be possible to heat the rollers to a lower temperature (or not at all) while still achieving a strong bond. Accordingly, in some embodiments, the nip rollers 204 may not be heated, and light energy emanating from a light energy source 210 may be used to effectuate the lamination. Where light energy is used, the substrate 102 may pass through the first set of nip rollers, and then move beneath the light energy source 210.

As shown in FIG. 1, the light energy 212 emitted from the light energy source 210 may penetrate the substrate 102 once the substrate 102 is adjacent the light source 210. The light energy 212 may penetrate through the transparent layer 104 reaching the adhesive layer 106. The light energy 212 may activate the adhesive layer 106 without activating the transparent layer 104, as described above. The activation of the adhesive may cause the adhesive layer 106 to soften, resulting in a bond with the top, bottom, and sides of the film.

Once the substrate 102 moves past the light energy source, the substrate 102 may pass through a second set of nip rollers 206 which apply pressure to the substrate 102. The nip rollers 206 may be chilled to aid in the cooling process. The substrate 102 may then move through cooling fans 208. As the temperature is lowered, the adhesive layer 106 may harden, creating a solid, strong, bonding layer. Finally, the substrate may wind through chill drums 214 and complete its pass through the lamination machine 200 through the out-feed pacing rollers 220. In this way, the substrate 102 may desirably and efficiently be laminated without curling or wrinkling.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention. It will be understood that certain features and subcombinations are of utility and may be employed without reference to other features and subcombinations. Not all steps listed in the various figures need be carried out in the specific order described.

1. A method for laminating a substrate, comprising the steps of:
providing a substrate comprising a transparent layer, an adhesive layer, and a core media layer;
applying a light energy source to the substrate;
applying pressure to the substrate; and
cooling the substrate;
wherein:
the light energy source activates the adhesive layer, causing the adhesive layer to soften, resulting in a bond between the transparent layer and the core media; and
cooling the substrate causes the adhesive layer to harden.

2. The method of claim 1, wherein the adhesive layer is a thermal formable plastic.

3. The method of claim 2, wherein the thermal formable plastic is a solid consisting of powder, film, or resin.

4. The method of claim 3, wherein the thermal formable plastic is poly-vinyl chloride.

5. The method of claim 4, wherein the light energy source is one of: a light emitting diode, a laser, a lamp, and solar.

6. The method of claim 5, wherein the method further comprises applying thermal energy to the substrate.

7. The method of claim 6, wherein the thermal energy does not cause curling and wrinkling of the substrate.

8. A method for laminating a substrate, comprising the steps of:
providing a substrate on a conveyor belt of a lamination machine, the substrate comprising a transparent layer, an adhesive layer, and a core media layer, the adhesive layer being positioned between the transparent layer and the core media layer;
moving the substrate through a first set of nip rollers;
applying a light energy source to the substrate;
moving the substrate through a second set of nip rollers to apply pressure to the substrate; and
moving the substrate through cooling fans;
wherein:
the light energy source activates the adhesive layer, causing the adhesive layer to soften and form a bond between the transparent layer and the core media layer; and
the cooling fans cool the substrate causing the adhesive layer to harden.

9. The method of claim 8, wherein the adhesive layer is a solid thermal formable plastic in the form of a powder, a film, or a resin.

10. The method of claim 9, wherein the light energy source is one of: a light emitting diode, a laser, a lamp, and solar.

11. The method of claim 10, wherein the light energy source activates the adhesive layer without activating the transparent layer.

12. The method of claim 11, wherein the first set of nip rollers is heated to aid in the activation of the adhesive layer, and wherein the temperature of the nip rollers does not cause curling or wrinkling of the substrate.

13. The method of claim 12, wherein the second set of nip rollers is chilled to aid in the cooling process.

14. A method for laminating a substrate, comprising the steps of:
providing a substrate on a conveyor belt of a lamination machine, the substrate comprising a transparent layer, an adhesive layer, and a core media layer, the adhesive layer being positioned between the transparent layer and the core media layer;
moving the substrate through a first set of heated nip rollers;
applying a light energy source to the substrate;
moving the substrate through a second set of chilled nip rollers to apply pressure to the substrate; and
moving the substrate through cooling fans;
wherein:
in combination, the heated nip rollers and the light energy source activates the adhesive layer, causing the adhesive layer to soften and form a bond between the transparent layer and the core media layer;
in combination, the cooled nip rollers and the cooling fans cool the substrate causing the adhesive layer to harden; and
the combined temperature of the heated nip rollers and the light energy source does not cause curling or wrinkling of the substrate.

15. The method of claim 14, wherein the light energy source is one of: a light emitting diode, a laser, a lamp, and solar.

16. The method of claim 15, wherein the adhesive layer is a thermal formable plastic.

17. The method of claim 16, wherein the thermal formable plastic is a solid consisting of powder, film, or resin.

18. The method of claim 17, wherein the thermal formable plastic is poly-vinyl chloride.

19. A method for laminating a substrate, comprising the steps of:
providing a substrate as a web in a lamination machine, the substrate comprising a transparent layer, an adhesive layer, and a core media layer, the adhesive layer being positioned between the transparent layer and the core media layer;
moving the substrate through a first set of nip rollers;
applying a light energy source to the substrate;
moving the substrate through a second set of nip rollers to apply pressure to the substrate; and
moving the substrate through cooling fans;
wherein:
the light energy source activates the adhesive layer, causing the adhesive layer to soften and form a bond between the transparent layer and the core media layer; and
the cooling fans cool the substrate causing the adhesive layer to harden.
